(19) United States
(12) Patent Application Publication
(10) Pub. No.: US 2002/0129537 A1
(43) Pub. Date: Sep. 19, 2002

(54) Fishing lures

(76) Inventors: Wayne Gathright, ElDorado, AR (US); Bruce Johnson, Montrose, AR (US); Jim Stephenson, Crossett, AR (US); Danny A. Gulledge, Hamburg, AR (US)

Correspondence Address: Dennis B. Haase, Post Office Box 3592, Little Rock, AR, 72203, US

(21) Appl. No.: 10/153,071

(22) Filed: May 21, 2002

Related U.S. Application Data
(63) Continuation of application No. 09/592,830, filed on Jun. 13, 2000.

(51) Int. Cl. A01K 85/00

(52) U.S. Cl. 43/42.25

(57) ABSTRACT

ABSTRACT OF THE INVENTION A unitary fishing lure molded of soft polymeric material and having an elongate body to which a tail portion is attached, and having a skirt comprising a series of contiguously circumferentially spaced tentacles disposed on the body remote from the head thereof, and a second set of circumferentially spaced whiskers immediately behind the head.

The present invention relates generally to fishing lures and, more particularly, to improvements in artificial soft plastic lures which provide enhanced visually active movements of the type which attract fresh, as well as salt water, fish.

### BACKGROUND OF THE INVENTION

1. Field of the Invention

The world's tackle box is replete with an array of lures which defy even the most ardent fisherman's wildest imagination. Each such lure represents someone's better idea, and the hope of coming up with the precise combination of enticements which will be the ultimate stimulant for the innate curiosity and pallette of the target fish.

Fishing, once a summer's day pass time for some, while a quest for food for others, has now become a hotly contested professional sport. There are, for example, bass tournaments throughout the United States, and spoils to be captured by the victors can range well into the six figures in cash and prizes.

The lure of the present invention has distinguished itself in that it has been on the hook of not one, but several fishing tournament winners from the time of its creation.

2. Overview of the Prior Art

The patent art is replete with a large, indeed almost incomprehensible, array of lures, seemingly of every shape and size, fashioned from an equally large number of materials. There is seemingly as many such lures that have not been patented for whatever reason. While the quantum of knowledge in the field is vast, there appears to be none, either present or past, which equals the capability of the following described lure.

There are many, for example, with an elongate body, examples of which include Davison U.S. Pat. No. 5,379,544, McClellan U.S. Pat. No. 4,051,619 and Hardwicke, III U.S. Pat. No. 4,312,148.

Many are intended to emulate a worm, Hardwicke III being an example of one such lure. And others perhaps, the legendary blue tail fly, along the lines of Rice U.S. Pat. No. 5,934,008.

Still others employ a dorsal fin to conceal a hook, e.g., as does Davidson, and shapes tend to boggle the imagination, but more typically are recognizable as denizens of the lakes and streams such as eels, frogs, and lizards.

There are some lures, such as those made by MIZMO of Jonesboro, Ark., which have skirts comprised of fingers extending outwardly. However, none appear to have the structure, nor the capacity, to move in the manner of the lure of the present invention.

### SUMMARY OF THE INVENTION

The present invention is about fishing and, more particularly, successful fishing, whether it be competitively, or for food, fun or relaxation.

To that end, it is a primary objective of the present invention to provide to the tournament competitor, as well as the recreational fisherman, a novel lure which, while in the water, emulates the appearance and movement of an edible morsel, readily recognizable by, and tempting to, a fish.

Another, yet related, objective of the present invention is to provide a lure which is so real in its appearance and movement as to be irresistible to an even moderately hungry, or simply curious, fish.

A further objective to be achieved by lure of the present invention is to effect a design which has a solid body and, notwithstanding its several collateral appendages, is capable of being molded in a single step to provide a homogeneous, unitary lure, ready to use right out of the mold.

The foregoing, as well as other objectives will become readily apparent to one skilled in the art from a further reading of the following detailed description of a preferred embodiment of the invention, taken in conjunction with the drawings, wherein:

### DESCRIPTION OF THE DRAWINGS

Appended is a sheet of drawings containing four figures in which:

FIG. 1 is a pictorial view of the lure of the present invention shown in perspective and illustrating the interrelationship of features of the lure which make it unique;

FIG. 2 is a view similar to FIG. 1, wherein the lure appears as it would if it were being reeled in after being cast;

FIG. 3 is a sectional view of the lure of FIG. 1, taken along lines 3-3 of FIG. 1; and

FIG. 4 is a partial sectional view of one of the tentacles in the skirt area of the lure.

### DESCRIPTION OF A PREFERRED EMBODIMENT OF THE INVENTION

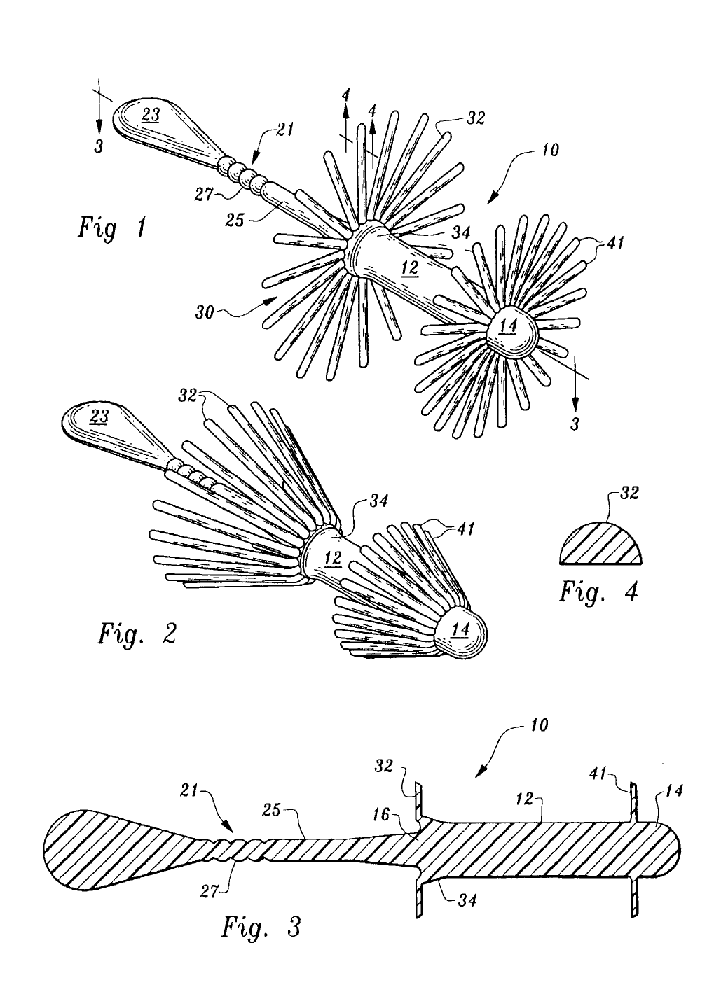

With reference now to the drawings, and initially to FIG. 1, there is illustrated a novel lure 10, molded of a soft, pliable polymeric material, and which has been constructed in accordance with the teachings of the invention.

The lure 10 is of unitary construction, and in its preferred form comprises a central cylindrical body 12, which is solid and formed, preferably by molding, of a flexible, very soft, plastic material. The body 12 defines, at the forward end, a rounded head portion 14 and opposite the head portion 14, is the remote end 16 of the body 12.

Integrally formed with the body 12 and extending rearwardly from the remote end 16 thereof, there is, in accordance with a feature of the invention, a tail 21.

The tail has a shape that is closely related, in profile, to an oar, in that it includes a flat paddle like end or terminus. It is uniquely designed to provide a wave motion while being pulled through the water, and, to this end, the paddle shaped end 23 will, in response to forward movement through the water, move to and fro as though acting like a rudder.

The paddle end is attached to the body 12 of the lure 10 by means of a cord 25, which is essentially cylindrical in shape, and at least a portion thereof serrated along lines 27 to appear to give the appearance of having series of body segments 28.

At the end of the cord 25, contiguous with the paddle end 23, the cord is formed with a series of serrations 27, which give the cord an appearance which is similar to, by way of example, a blue tail fly. When pulled through the water, the tail is so configured as to wiggle and dive in an essentially random motion, suggesting a living thing.

As a means of enhancing the motion of the lure as it is pulled through the water to thereby attract attention thereto, the lure 10 is further provided with skirt 30 which circumscribes, and is integrally formed with the body 12, and from which extends a series of contiguously circumferentially spaced, outwardly extending hair like tentacles 32, formed on a belt like area 34.

As will be appreciated from FIGS. 1 and 2, the tentacles encircle the remote end 16 of the cylindrical body 12, projecting outwardly therefrom in such a manner that as the lure is reeled in by the fisherman, the tentacles, which in cross section appear as in FIG. 4, will assume an essentially random wavy motion, freely moving as the water currents and line pressure guide them. The fisherman can manipulate and control the movement by varying the consistency of the pressure applied on the line as the lure is reeled in, which may even flutter and undulate like hairs, and the movement is further enhanced by random lessening and increasing tension on the line, giving the lure the appearance of a live, edible creature.

As an adjunct to the skirt 30, the lure 10 is additionally provided with a series of circumferentially disposed whiskers 41. The whiskers 41 encircle the body 12 of the lure 10 immediately behind the head portion 14, and each such whisker comprises an outwardly extending flexible hair like member having an essentially elliptical cross section such as that shown in FIG. 4.

As in the case of the skirt and its outwardly projecting tentacles, the whiskers 41 are responsive to the currents in the water as well as the tug or pull on the line as the lure is being reeled in, resulting in a motion which suggests the presence of a living creature which is indigenous to the customary diet of fresh water fish.

The whiskers 41 are preferably somewhat shorter than the tentacles 32, and perhaps somewhat less in cross section, thereby giving shape to the lure which is in keeping with the objective of simulating a living creature in motion in the water.

It will, of course, be understood that a hook (not shown, since its precise position is a matter of choice) would necessarily be inserted into the body 12 of the lure 10 in any number of ways depending on the preference of the user, including but not limited to, being placed through the body and the head portion 14 in such a manner that it is relatively unobservable to a fish until is too late to be avoided.

It will be appreciated by those skilled in the art that some variation in the construction of the lure of the present invention may be anticipated without departure from the invention, and, indeed, the size may be matched to the fish being sought, whether in fresh or salt water, and, which is defined by the appended claims, wherein:

1. A unitary fishing lure molded of a soft, pliable, polymeric material, comprising:
an elongate solid body; said body terminating in a head portion;
a tail integrally formed with said body, said tail being remote from said head and terminating in a paddle like end;
a skirt, said skirt being integrally formed with and circumscribing said body at a position between said head thereof and said tail;
said skirt including a series of circumferentially spaced tentacles, extending outwardly therefrom; and
a series of whiskers disposed immediately behind said head, and circumscribing said body.

2. The unitary fishing lure of claim 1 wherein said tail comprises a cord disposed between and attached, respectively, to said paddle like end and said body.

3. The unitary fishing lure of claim 1 wherein said tentacles are contiguous.

4. The unitary fishing lure of claim 1 wherein said skirt is at the end of said body remote from the head thereof.

5. The unitary fishing lure of claim 1 wherein said whiskers are circumferentially disposed about said body.

6. The unitary fishing lure of claim 1 wherein said tentacles are elliptical in cross section.

7. The unitary fishing lure of claim 2 wherein said cord is formed with a series of serrations.

8. The unitary fishing lure of claim 2 wherein said whiskers are circumferentially disposed about said body.

9. The unitary fishing lure of claim 2 wherein said skirt includes a belt, and said tentacles extend outwardly from said belt.

10. The unitary fishing lure of claim 2 wherein said tail comprises a cord, disposed between and attached respectively to said paddle like end and said body; said skirt includes a belt, and said tentacles extend outwardly from said belt.
